(19) United States
(12) Patent Application Publication
(10) Pub. No.: US 2022/0320742 A1
(43) Pub. Date: Oct. 6, 2022

(54) ANTENNA ELEMENT

(71) Applicant: NEC Corporation, Minato-ku, Tokyo (JP)

(72) Inventor: Naoyuki ORIHASHI, Tokyo (JP)

(73) Assignee: NEC Corporation, Minato-ku, Tokyo (JP)

(21) Appl. No.: 17/615,926

(22) PCT Filed: May 14, 2020
(86) PCT No.: PCT/JP2020/019210

§ 371 Date: Dec. 2, 2021

(30) Foreign Application Priority Data
Jun. 5, 2019 (JP) 2019-105102

(51) Int. Cl. H01Q 13/08; H01Q 19/185

(52) U.S. Cl. CPC H01Q 13/08; H01Q 19/185

(57) ABSTRACT

An antenna element according to the present invention includes a substrate, an emitting element disposed on the substrate, and metal patterns formed in the same surface of the same substrate as those of the emitting element, and disposed so as to be in an electrically floating state, in which the metal patterns are disposed at such positions that the metal patterns have a specific distance from the emitting element.

### TECHNICAL FIELD

The present invention relates to an antenna element, and in particular to an antenna element that controls the directivity of emitted waves emitted from an emitting element.

### BACKGROUND ART

The emission of electromagnetic waves in the horizontal direction by an antenna element (especially a planar antenna) not only affects antenna elements and components around the antenna element, but also affects emitting patterns of the antenna itself. This is because since the wavelength of electromagnetic waves in the frequency band is about 0.1 mm to 10 mm, and the thickness of circuit components and antenna substrates around the antenna element is roughly equal to the wavelength of the aforementioned frequency band, reflection and diffraction caused by these components cannot be ignored. Therefore, in the design of radio apparatuses and communication apparatuses such as radar apparatuses, it is a significant challenge to suppress and control the emission of electromagnetic waves in the horizontal direction by an antenna element, especially an antenna element that emits millimeter waves or submillimeter waves.

Patent Literature 1 discloses an example of a technique for controlling the directivity of radio waves. Patent Literature 1 discloses, in claim 1, the following features of a microstrip line. The microstrip line includes: a substrate; feeding elements disposed on the front surface of the substrate; passive elements disposed in a predetermined inter-element space away from the feeding elements disposed on the front surface of the substrate; and grounding means for performing switching as to whether the passive elements are grounded or brought into a floating state, in which: grounding points of the passive elements are located at least 0.25 L away from the centers of the passive elements in the excitation direction thereof and are disposed within ±0.1 W from the centers of the passive elements in the direction perpendicular to the excitation direction, where W is the length of the passive elements in the direction perpendicular to the excitation direction; the passive elements are arranged, in the direction perpendicular to the excitation direction, at axial-symmetric positions with respect to the feeding element located at the center, and are arranged at left and right positions equidistant from the feeding element, and passive elements are further arranged on the outer side of the aforementioned passive elements; and the positions of feeding points of the feeding elements and the grounding points of the passive elements are arranged in a staggered manner.

### CITATION LIST

### Patent Literature

Patent Literature 1: Japanese Unexamined Patent Application Publication No. 2007-037158

### SUMMARY OF INVENTION

### Technical Problem

In the technique described in Patent Literature 1, the phases of emitted waves from the passive elements are adjusted by turning on/off switches provided in the respective passive elements. Further, the phases of emitted waves are switched by switching the excitation states of the passive elements by turning on/off switches. Therefore, there is a restriction that the length of at least one side of the passive element has to be roughly equal to that of the feeding element. As described above, the technique described in Patent Literature 1 has a problem that the number of components is increased in order to control the directivity of radio waves, and another problem that the flexibility of the design is limited because the shape of the passive element is restricted.

### Solution to Problem

In an aspect according to the present invention, an antenna element includes: a substrate; an emitting element disposed on the substrate; and a metal pattern formed in the same surface of the same substrate as those in which the emitting element is formed, and disposed so as to be in an electrically floating state, in which the metal pattern is disposed at such a position that the metal pattern is at a specific distance from the emitting element.

### Advantageous Effects of Invention

According to the antenna element in accordance with the present invention, it is possible to provide an antenna element that is formed by a small number of components and can be flexibly designed.

### BRIEF DESCRIPTION OF DRAWINGS

FIG. 1 shows schematic diagrams of an antenna element according to a first example embodiment;

FIG. 2 is diagram for explaining an operation of the antenna element according to the first example embodiment;

FIG. 3 shows an example of a structure of an antenna element according to the first example embodiment;

FIG. 4 is a graph of emitting pattern characteristics showing an effect of the antenna element shown in FIG. 3;

FIG. 5 shows schematic diagrams of a modified example of the antenna element according to the first example embodiment;

FIG. 6 is a schematic diagram of an antenna element according to a second example embodiment;

FIG. 7 is a schematic diagram of an antenna element according to a third example embodiment;

FIG. 8 is a schematic diagram of an antenna element according to a fourth example embodiment;

FIG. 9 is a schematic diagram of a first example of an antenna element according to a fifth example embodiment;

FIG. 10 is a schematic diagram of a second example of the antenna element according to the fifth example embodiment;

FIG. 11 is a schematic diagram for explaining a first example of an antenna element according to a sixth example embodiment;

FIG. 12 is a schematic diagram for explaining a second example of the antenna element according to the sixth example embodiment;

FIG. 13 is a schematic diagram of an antenna element according to a seventh example embodiment; and

FIG. 14 is a schematic diagram of an antenna element according to an eighth example embodiment.

### DESCRIPTION OF EMBODIMENTS

### First Example Embodiment

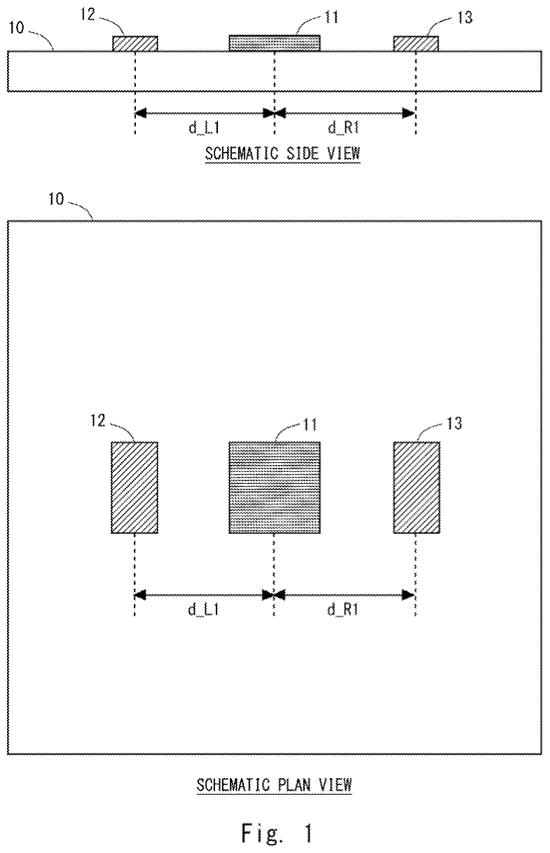

Example embodiments according to the present invention will be described hereinafter with reference to the drawings. FIG. 1 shows schematic diagrams of an antenna element 1 according to a first example embodiment. An upper part of FIG. 1 shows a schematic diagram of the antenna element 1 as viewed from a side thereof, and a lower part of FIG. 1 shows a schematic diagram of the antenna element 1 as viewed from above it.

As shown in FIG. 1, the antenna element 1 according to the first example embodiment has a substrate 10, an emitting element 11, a first metal pattern (e.g., a metal pattern 12), and a second metal pattern (e.g., a metal pattern 13).

In the antenna element 1 according to the first example embodiment, the emitting element 11 is formed on a predetermined surface of the substrate 10. The emitting element 11 emits electromagnetic waves based on electric power output from an electric power source (not shown). In the following description, electromagnetic waves emitted by the emitting element 11 are referred to as emitted waves. Further, the metal patterns 12 and 13 are formed in the antenna element 1 according to the first example embodiment. The metal patterns 12 and 13 are disposed on, among the surfaces of the substrate, an antenna-forming surface on which the emitting element 11 is formed. In the example shown in FIG. 1, the metal pattern 12 is formed on the left side of the emitting element 11 in the drawing and at such a position that the metal pattern 12 is at a distance d_L1 from the emitting element 11. Further, the metal pattern 13 is formed on the right side of the emitting element 11 in the drawing and at such a position that the metal pattern 13 is at a distance d_R1 from the emitting element 11. These distances d_L1 and d_R1 are defined by Expressions (1) and (2), respectively, which will be described later. Further, the distances d_L1 and d_R1 are independent of each other. In the following description, a distance d is used as a term to indicate either the distance d_L1 or the distance d_R1.

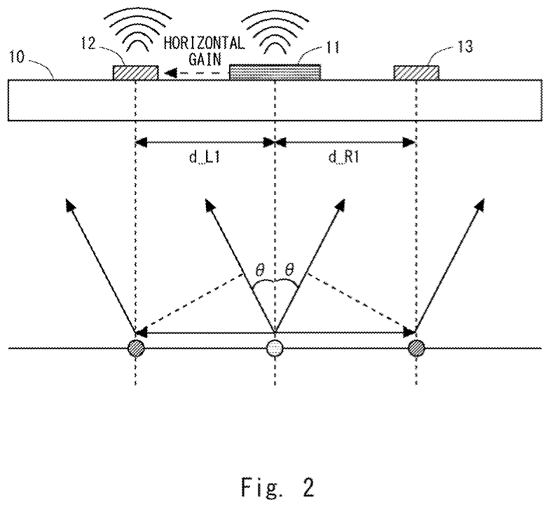

An operation of the antennal element according to the first example embodiment will be described with reference to FIG. 2. Emitted waves are emitted from the emitting element 11. In particular, emitted waves emitted from the emitting element 11 in the horizontal direction are scattered when they reach the metal patterns 12 and 13, and are re-emitted in all directions from the metal patterns 12 and 13. As a result, the strength of the emitted waves in the horizontal direction decreases. Meanwhile, the scattered waves that are re-emitted from the metal patterns 12 and 13 interfere with the emitted waves emitted from the emitting element 11, so that the emitted waves and the scattered waves strengthen each other or weaken each other. Note that the direction in which the interference effect between the emitted waves and the scattered waves occurs changes depending on the distance between the emitting element 11 and the metal pattern. Therefore, it is possible to strengthen or weaken electromagnetic waves traveling in a desired direction θ by appropriately setting the distance between the emitting element 11 and the metal pattern.

The distance d will be described hereinafter. The distance d can be classified into a distance d1 at which the emitted waves and the scattered waves strengthen each other, and a distance d2 at which the emitted waves and the scattered waves weaken each other. The distance d1 is expressed by the Expression (1), and the distance d2 is expressed by the Expression (2). In the expressions: n is an integer; λ is a wavelength of emitted waves; and θ is an angle of a desired direction.

$$\text{[Expression 1]}$$

$$d 1 = \frac{n λ}{1 - sin θ} \qquad ( 1 )$$

$$[ Expression 2 ]$$

$$d 2 = ( n + \frac{1}{2} ) λ \cdot \frac{1}{1 - sin θ} \qquad ( 2 )$$

It is possible to control the strength of an electric field in a desired direction by setting the distance d to the distance d1 expressed by the Expression (1) or the distance d2 expressed by the Expression (2).

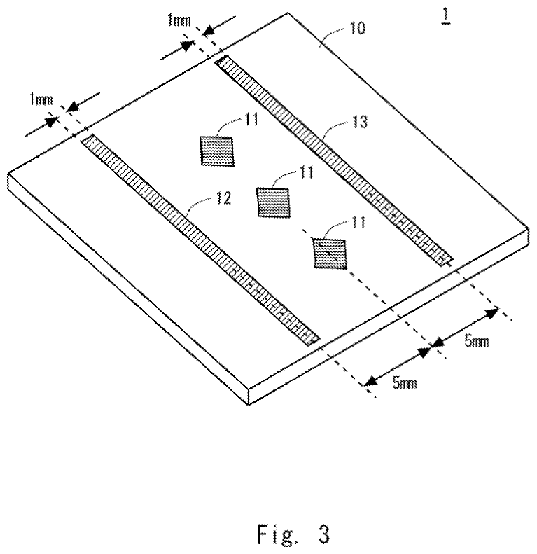

An operation of the antenna element 1 according to the first example embodiment will be described in detail by using an example in which the distance d between the emitting element 11 and each of the metal patterns 12 and 13 is set to the distance d1. FIG. 3 shows an example of a structure of an antenna element according to the first example embodiment. In this antenna structure, three emitting elements 11 are formed on a substrate 10. The set frequency of the emitting elements 11 is 60 GHz. Metal patterns 12 and 13 are formed on both sides of the emitting elements 11. Further, in the example shown in FIG. 3, the line width of each of the metal patterns 12 and 13 is set to 1 mm, and the distances d_L1 and d_R1 are both set to 5 mm. Each of these distances d_L1 and d_R1 is the distance expressed by the Expression (1).

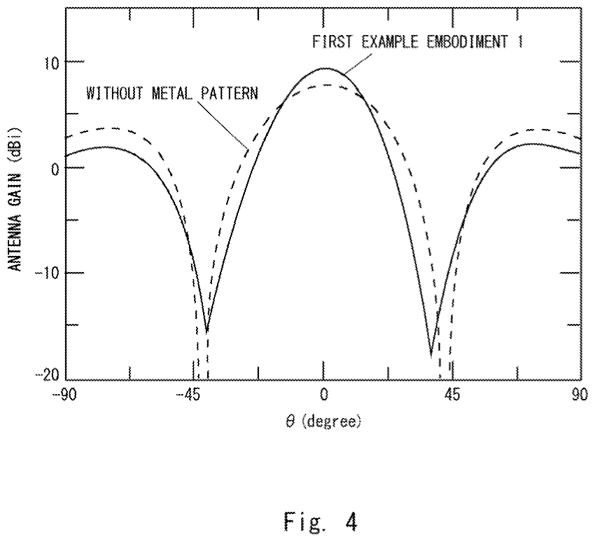

FIG. 4 shows emitting-pattern characteristics showing an effect of the antenna element 1 shown in FIG. 3. As a comparative example, FIG. 4 also shows emitting-pattern characteristics of an antenna element that is identical to the antenna element 1 shown in FIG. 3 except that the metal patterns 12 and 13 are not provided. As shown in FIG. 4, it can be understood that the antenna gain in the horizontal direction (±90°) of the antenna element 1 according to the first example embodiment is lower than that of the antenna element according to the comparative example by about 3 dB, and the antenna gain in the vertical direction of the antenna element 1 according to the first example embodiment is higher than that of the antenna element according to the comparative example.

From the above-described facts, in the antenna element 1 according to the first example embodiment, it is possible to control the strength of an electric field in a desired direction (in the vertical direction in the above-shown analytic example) while suppressing the gain in the horizontal direction by providing the metal patterns 12 and 13 on both sides of the emitting element 11 on the substrate 10 and setting the distance between the emitting element 11 and each of the metal patterns 12 and 13 based on the Expression (1). Further, although no specific example is shown, it is possible to control the strength of an electric field in a desired direction while suppressing the gain in the horizontal direction by setting the distance between the emitting element 11 and each of the metal patterns 12 and 13 based on the Expression (2).

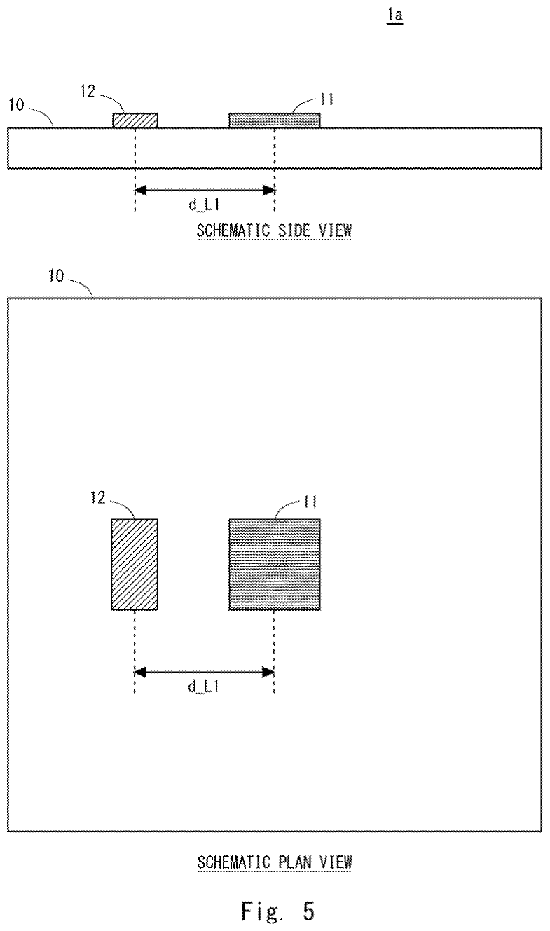

Note that although the metal patterns 12 and 13 are arranged on both sides of the emitting element 11 in the first example embodiment, it is also possible to suppress the gain only on one side in the horizontal direction by disposing a metal pattern only on the one side. Therefore, FIG. 5 shows schematic diagrams of an antenna element 1a according to the first example embodiment in which a metal pattern is disposed only on one side. In the example shown in FIG. 5, the metal pattern 12 is disposed only on the left side of the emitting element 11 and the metal pattern 13 is not provided. By using the above-described structure, it is possible to suppress only the antenna gain in the horizontal direction only on the left side in the drawing, and to control the strength of an electric field in a desired at the same time.

In the antenna element 1 according to the first example embodiment, it is unnecessary to connect the metal patterns 12 and 13 to the ground, and therefore it is unnecessary to form (i.e., provide) switches which are necessary in the microstrip antenna disclosed in Patent Literature 1. Further, there is no need to form a wiring structure (e.g., through holes) to connect the metal patterns 12 and 13 to the rear surface of the substrate (or a ground layer inside the substrate). That is, the antenna element 1 according to the first example embodiment have such features that it is possible to control the strength of an electric field in a desired direction while suppressing the strength of an electric field in the horizontal direction by using a structure simpler than that of the microstrip antenna disclosed in Patent Literature 1.

### Second Example Embodiment

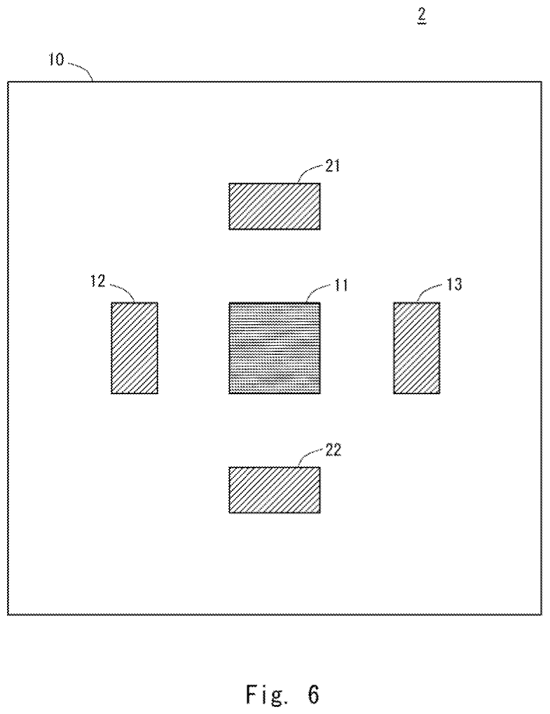

In a second example embodiment, an antenna element 2, which is a modified example of the antenna element 1 according to the first example embodiment, will be described. Therefore, FIG. 6 shows a schematic diagram of the antenna element 2 according to the second example embodiment. Note that, in the description of the second example embodiment, the same components as those in the first example embodiment are denoted by the same reference numerals (or symbols) as those in the first example embodiment, and the descriptions thereof are omitted.

As shown in FIG. 6, the antenna element 2 according to the second example embodiment is obtained by adding third and fourth metal patterns (e.g., metal patterns 21 and 22) in the antenna element 1. The metal patterns 21 and 22 are disposed at positions a specific distance (e.g., a distance determined by the Expression (1) or (2)) away from the emitting element 11 in a second direction (e.g., the up/down direction in the drawing) perpendicular to a first direction (e.g., the left/right direction in the drawing) from the metal pattern 12 toward the metal pattern 13. Further, in the example shown in FIG. 6, the metal patterns 21 and 22 are arranged at up/down symmetric positions with respect to the emitting element 11.

By arranging metal patterns not only in the left/right direction of the emitting element 11 but also in the up/down direction thereof, it is possible to set emitting patterns of emitted waves not only in the left/right direction in the drawing but also in the up/down direction therein.

### Third Example Embodiment

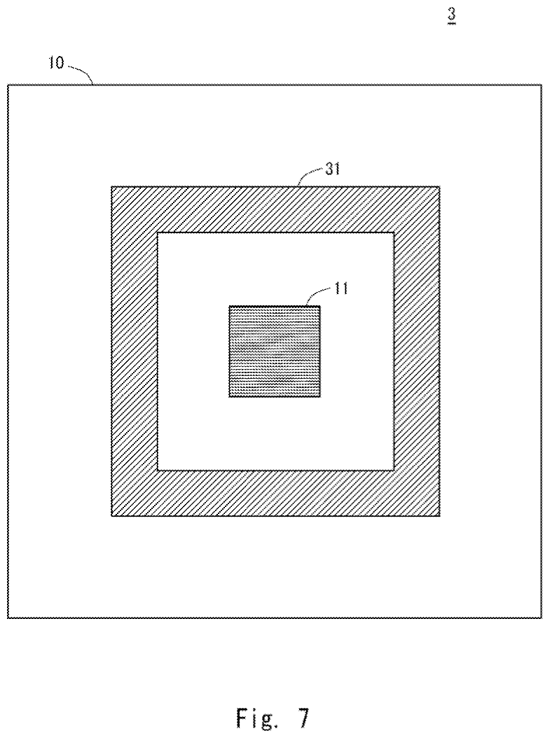

In a third example embodiment, an antenna element 3, which is a modified example of the antenna element 1 according to the first example embodiment, will be described. Therefore, FIG. 7 shows a schematic diagram of the antenna element 3 according to the third example embodiment. Note that, in the description of the third example embodiment, the same components as those in the first example embodiment are denoted by the same reference numerals (or symbols) as those in the first example embodiment, and the descriptions thereof are omitted.

As shown in FIG. 7, the antenna element 3 according to the third example embodiment includes a metal pattern 31 in place of the metal patterns 12 and 13. The metal pattern 31 is a continuous metal pattern formed so as to surround the emitting element 11. Further, the sides of the metal pattern 31 in the left/right direction in the drawing are parts that correspond to the metal patterns 12 and 13. Further, the sides of the metal pattern 31 in the up/down direction in the drawing are parts that correspond to the metal patterns 21 and 22 according to the second example embodiment.

By surround the emitting element 11 by the metal pattern 31 as described above, it is possible to make emitted waves from the emitting element 11 and scattered waves from the metal pattern 31 interfere with each other as in the case of the first example embodiment. That is, the third example embodiment is for describing another form of the antenna element according to the first or second example embodiment.

### Fourth Example Embodiment

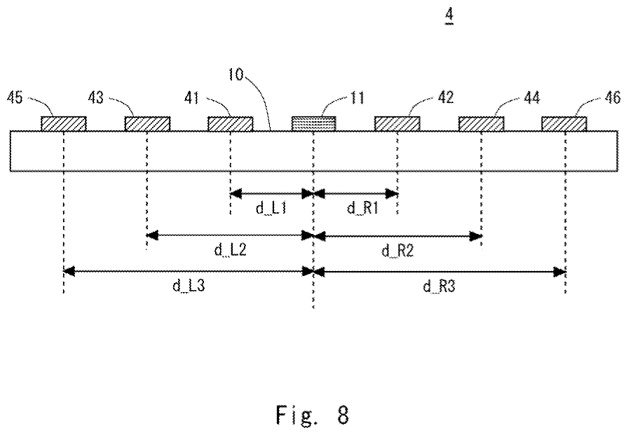

In a fourth example embodiment, an antenna element 4, which is a modified example of the antenna element 1 according to the first example embodiment, will be described. Therefore, FIG. 8 shows a schematic diagram of the antenna element 4 according to the fourth example embodiment. Note that, in the description of the fourth example embodiment, the same components as those in the first example embodiment are denoted by the same reference numerals (or symbols) as those in the first example embodiment, and the descriptions thereof are omitted.

As shown in FIG. 8, the antenna element 4 according to the fourth example embodiment includes a plurality of metal patterns (i.e., a plurality of metal pieces) arranged in the left/right direction in the drawing. Note that distances from the emitting element 11 to metal patterns from 41 to 46 in FIG. 8 are set to distances d_L1 to d_L3 and distances d_R1 to d_R3, respectively, which are determined by the Expression (1) or (2).

### Fifth Example Embodiment

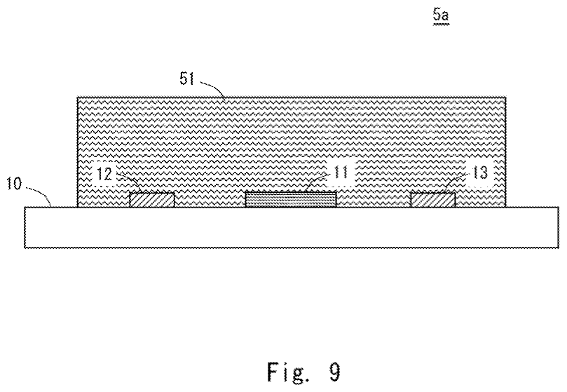

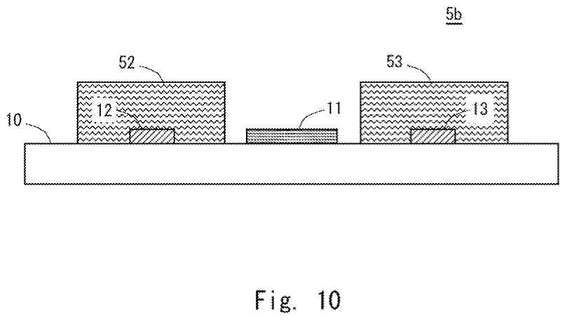

In a fifth example embodiment, antenna elements 5a and 5b which are modified examples of the antenna element 1 according to the first example embodiment, will be described. Therefore, FIG. 9 shows a schematic diagram of the antenna element 5a according to the fifth example embodiment, and FIG. 10 shows a schematic diagram of the antenna element 5b according to the fifth example embodiment. Note that, in the description of the fifth example embodiment, the same components as those in the first example embodiment are denoted by the same reference numerals (or symbols) as those in the first example embodiment, and the descriptions thereof are omitted.

In the antenna element 5a according to the fifth example embodiment shown in FIG. 9, a resin film 51 is formed on the antenna-forming surface of the antenna element 1 according to the first example embodiment so as to cover the emitting element 11, and the metal patterns 12 and 13.

Further, in the antenna element 5b according to the fifth example embodiment shown in FIG. 10, resin films 52 and 53 are formed so as to selectively cover the metal patterns 12 and 13 on the antenna-forming surface of the antenna element 1 according to the first example embodiment. Note that the emitting element 11 is not covered by the resin films in the antenna element 5b.

It is possible to protect the antenna pattern by forming a resin film(s) that covers the emitting element 11 and the metal patterns 12 and 13 on the antenna-forming surface. Note that when a resin film(s) is formed, the wavelength λ of emitted waves in the Expressions (1) and (2) becomes an effective wavelength for which the dielectric constant of the resin film(s) is taken into consideration.

### Sixth Example Embodiment

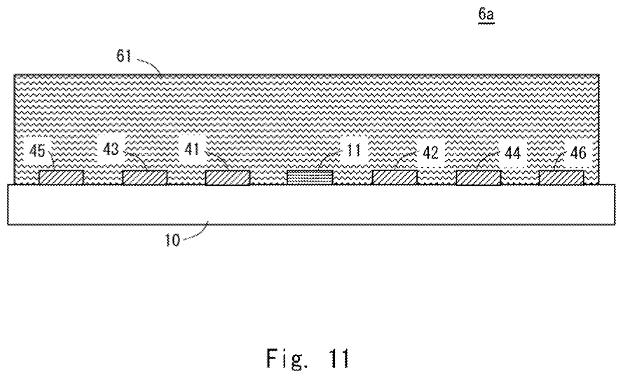

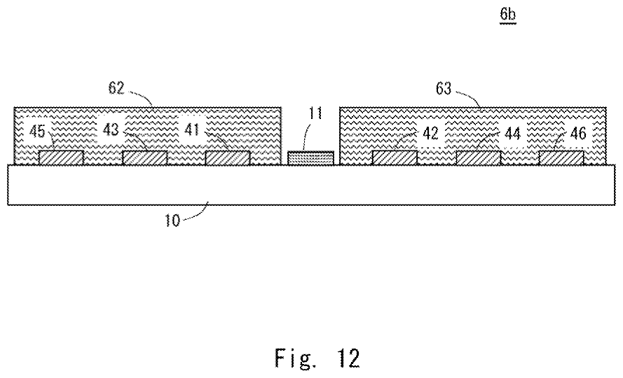

In a sixth example embodiment, antenna elements 6a and 6b which are modified examples of the antenna element 4 according to the fourth example embodiment, will be described. Therefore, FIG. 11 shows a schematic diagram of the antenna element 6a according to the sixth example embodiment, and FIG. 12 shows a schematic diagram of the antenna element 6b according to the sixth example embodiment. Note that, in the description of the sixth example embodiment, the same components as those in the first or fourth example embodiment are denoted by the same reference numerals (or symbols) as those in the first or fourth example embodiment, and the descriptions thereof are omitted.

As shown in FIG. 11, in the antenna element 6a according to the sixth example embodiment, a resin film 61 is formed on the antenna-forming surface of the antenna element 4 according to the fourth example embodiment so as to cover the emitting element 11, and the metal patterns 41 to 46.

Further, as shown in FIG. 12, in the antenna element 6b according to the sixth example embodiment, resin films 62 and 63 are formed on the antenna-forming surface of the antenna element 4 according to the fourth example embodiment so as to selectively cover the metal patterns 41 to 46. Note that the emitting element 11 is not covered by the resin films in the antenna element 6b.

It is possible to protect the antenna pattern by forming a resin film(s) that covers the emitting element 11 and the metal patterns 41 to 46 on the antenna-forming surface. Note that when a resin film(s) is formed, the wavelength λ of emitted waves in the Expressions (1) and (2) becomes an effective wavelength for which the dielectric constant of the resin film(s) is taken into consideration.

### Seventh Example Embodiment

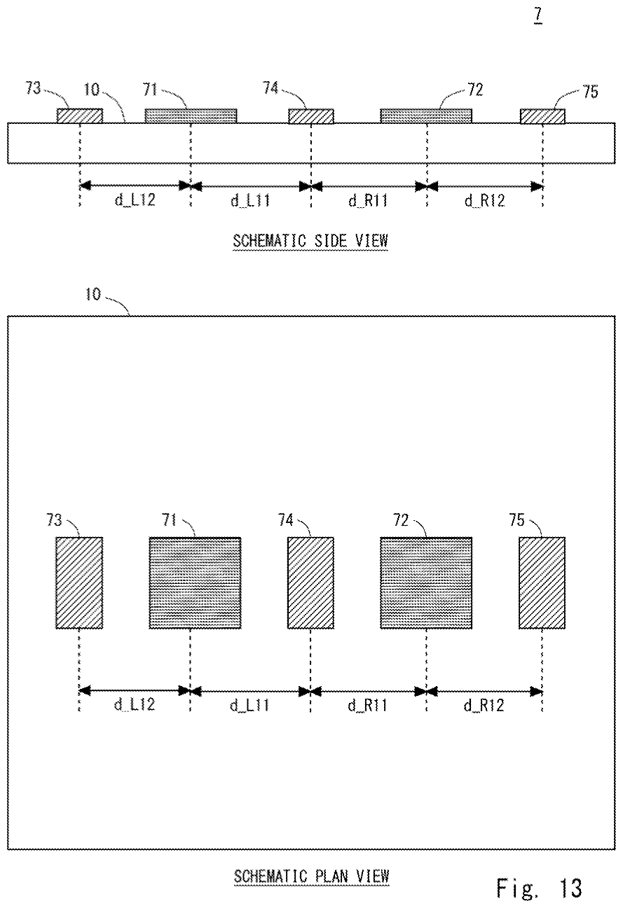

In a seventh example embodiment, an antenna element 7, which is a modified example of the antenna element 1 according to the example embodiment, will be described. Therefore, FIG. 13 shows a schematic diagram of the antenna element 7 according to the seventh example embodiment. Note that, in the description of the seventh example embodiment, the same components as those in the first example embodiment are denoted by the same reference numerals (or symbols) as those in the first example embodiment, and the descriptions thereof are omitted.

As shown in FIG. 13, the antenna element 7 according to the seventh example embodiment includes a plurality of antenna elements (two emitting elements 71 and 72 in FIG. 8). Further, the antenna element 7 according to the seventh example embodiment includes a metal pattern 74 disposed between the emitting elements 71 and 72, a metal pattern 73 disposed on the outer side of the emitting element 71, and a metal pattern 75 disposed on the outer side of the emitting element 72. Further, distances between neighboring ones of these elements are set to specific distances d_L11, d_L12, d_R11 and d_R12, respectively, determined by the Expression (1) or (2).

By providing a plurality of emitting elements and providing metal patterns between the emitting elements and on outer sides of the emitting elements, it is possible to control the strength of an electric field for each of a plurality of emitted waves emitted from the plurality of emitting elements.

### Eighth Example Embodiment

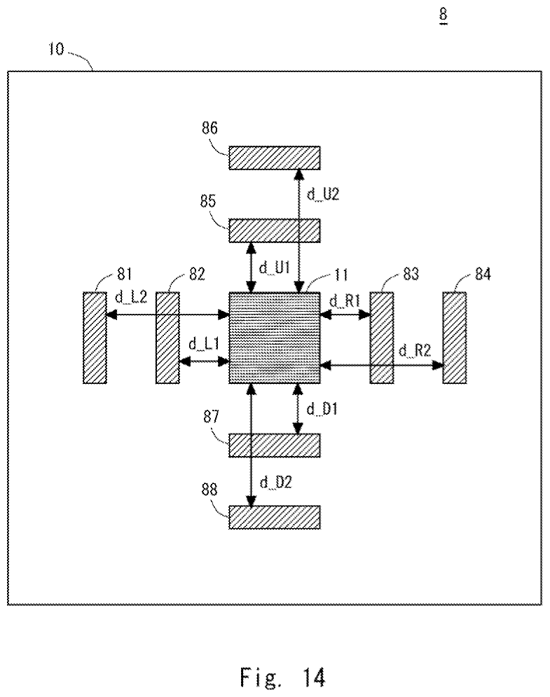

In an eighth example embodiment, an antenna element 8, which is a modified example of the antenna element 2 according to the second example embodiment, will be described. Therefore, FIG. 14 shows a schematic diagram of the antenna element 8 according to the eighth example embodiment. Note that, in the description of the eighth example embodiment, the same components as those in the first or second example embodiment are denoted by the same reference numerals (or symbols) as those in the first or second example embodiment, and the descriptions thereof are omitted.

As shown in FIG. 14, in the antenna element 8 according to the eighth example embodiment, each of first to fourth metal patterns includes (i.e., is composed of) a plurality of metal patterns (i.e., a plurality of metal pieces). Specifically, in the example shown in FIG. 14, the first metal pattern includes metal patterns (i.e., metal pieces) 81 and 82, and the second metal pattern includes metal patterns (i.e., metal pieces) 83 and 84. Further, the third metal pattern includes metal patterns (i.e., metal pieces) 85 and 86, and the fourth metal pattern includes metal patterns 87 and 88 (i.e., metal pieces). Further, distances between the emitting element 11 and these metal patterns (i.e., metal pieces) are set to specific distances d_L1, d_L2, d_R1, d_R2, d_U1, d_U2, d_D1 and d_D2, respectively, determined by the Expression (1) or (2).

Since each of a group of metal patterns which are arranged so as to surround the emitting element 11 includes a plurality of metal patterns (i.e., metal pieces), it is possible to suppress the antenna gain in the horizontal direction.

Note that the present invention is not limited to the above-described example embodiments, and they can be modified as appropriate without departing from the scope and spirit of the invention. For example, the present invention can be applied to various forms of antennas as well as to planar antennas.

This application is based upon and claims the benefit of priority from Japanese patent application No. 2019-105102, filed on Jun. 5, 2019, the disclosure of which is incorporated herein in its entirety by reference.

REFERENCE SIGNS LIST

### 1-8 ANTENNA ELEMENT

### 10 SUBSTRATE

### 11, 71, 72 EMITTING ELEMENT

### 12, 13, 21, 22, 31 METAL PATTERN

### 41-46, 73-75, 81-88 METAL PATTERN

### 51-53, 61-63 RESIN FILM

What is claimed is:

1. An antenna element comprising:
a substrate;
an emitting element disposed on the substrate; and
a metal pattern formed in the same surface of the same substrate as those in which the emitting element is formed, and disposed so as to be in an electrically floating state, wherein
the metal pattern is disposed at such a position that the metal pattern is at a specific distance from the emitting element.

2. The antenna element according to claim 1, wherein the specific distance is a first distance at which an emitted wave emitted by the emitting element and a scattered wave emitted by the metal pattern strengthen each other, or a second distance at which the emitted wave and the scattered wave weaken each other.

3. The antenna element according to claim 1, wherein metal patterns are arranged at both sides of the emitting element in a left/right direction, both sides of the emitting element in an up/down direction, or both sides of the emitting element in the left/right direction and both sides of the emitting element in the up/down direction.

4. The antenna element according to claim 1, wherein the metal pattern is formed as a continuous metal pattern surrounding the emitting element.

5. The antenna element according to claim 1, wherein
a plurality of metal patterns are arranged in a direction in which they recede from the emitting element, and
each of distances from the emitting element to the plurality of metal patterns is a first distance at which an emitted wave emitted by the emitting element and a scattered wave emitted by the metal pattern strengthen each other, or a second distance at which the emitted wave and the scattered wave weaken each other.

6. The antenna element according to claim 1, further comprising a resin film covering the emitting element and the metal pattern.

7. The antenna element according to claim 1, further comprising a resin film selectively covering the metal pattern.
